(19) United States
(12) Patent Application Publication
(10) Pub. No.: US 2010/0107094 A1
(43) Pub. Date: Apr. 29, 2010

(54) Advertising request and rules-based content provision engine, system and method

(76) Inventors: Ryan Steelberg, Irvine, CA (US); Chad Steelberg, Newport Beach, CA (US)

Correspondence Address: DRINKER BIDDLE & REATH;ATTN: INTELLECTUAL PROPERTY GROUP, ONE LOGAN SQUARE, 18TH AND CHERRY STREETS, PHILADELPHIA, PA, 19103-6996, US

(21) Appl. No.: 12/586,438

(22) Filed: Sep. 22, 2009

Related U.S. Application Data
(60) Provisional application No. 61/100,451, filed on Sep. 26, 2008.
(60) Provisional application No. 61/100,447, filed on Sep. 26, 2008.

(51) Int. Cl. G06F 3/048; G06N 5/02

(52) U.S. Cl. 715/763; 706/47

(57) ABSTRACT

The present invention includes an approval engine for pre-approving media content by which a user can interact with an ad generator and request at least one content item not owned by the user for inclusion in a creative. The approval engine also includes a content provision rules engine that includes a plurality of rules asserted by the owner of the requested content to govern the inclusion of the content in the creative, where ones of the plurality of rules includes a minimum price. The content provision rules engine further includes a content provision interface by which the owner of the requested content can interact with the content rules engine to assert the plurality of rules. The user then receives authorization to include the requested content upon meeting the requirements of each of the plurality of rules asserted by the owner prior to the content request made by the user.

### CROSS-REFERENCE TO RELATED APPLICATIONS

This application claims priority to U.S. Provisional Application No. 61/100,451 entitled “An Advertising Request and Rules-Based Content Provision Engine, System and Method,” filed Sep. 26, 2008, and to U.S. Provisional Application No. 61/100,447 entitled “An Advertising Request and Rules-Based Content Provision Engine, System and Method,” filed Sep. 26, 2008, the entire disclosures of which are incorporated by reference herein as if set forth in its entirety.

This application is related to U.S. patent application Ser. No. 11/981,837, filed Oct. 31, 2007, which is related to concurrently filed U.S. patent application Ser. No. 11/981,646, filed Oct. 31, 2007, and which claims the benefit of U.S. Provisional Application Ser. No. 60/993,096, filed Sep. 7, 2007, the entire disclosures of which are incorporated by reference herein as if set forth in their entireties, respectively.

### FIELD OF THE INVENTION

The present invention is directed to an advertising engine and, more particularly, to an advertising request and rules-based content provision engine, and a method of making and using same.

### BACKGROUND OF THE INVENTION

In the current art, a true marketplace for endorsed advertising is not available. This is due, in part, to the lack of a convenient clearinghouse that might allow for application of rules preferred by prospective endorsers before such prospective endorsers would allow use of an endorsement. For example, the process of gaining approval from an endorser requires the tracking down of the desired media content, figuring out who and how to contact the agent representing that endorser, scheduling meetings and possibly traveling to meet and discuss the licensing opportunities with the agent, and passing back and forth unfamiliar contractual forms including language that is unique for that agent. It goes without saying that the propensity for “red tape” is extremely high.

Thus, there exists a need for an apparatus, system and method that would provide a convenient clearinghouse and approval mechanism for application of rules preferred by prospective endorsers before such prospective endorsers would allow use of an endorsement to streamline the approval process for licensing media assets.

### SUMMARY OF THE INVENTION

The present invention includes a multi-step approval engine for approving media content. The multi-step approval engine includes an ad generator and an ad generator interface by which a user can interact with the ad generator, where the user requests at least one content item not owned by the user for inclusion in a creative. The multi-step approval engine also includes a content provision rules engine that includes a first plurality of rules asserted by the owner of the requested content to govern the inclusion of the content in the creative, where ones of the plurality of rules includes a minimum price, and a second plurality of rules asserted by the owner of the requested content to review the creative subsequent to inclusion of the requested content in the creative. The content provision rules engine further includes a content provision interface by which the owner of the requested content can interact with the content rules engine to assert the first and second plurality of rules. The user then receives a first authorization to include the requested content upon meeting the requirements of each of the first plurality of rules, and the owner of the requested content then reviews the creative having the requested content incorporated therein to provide a second authorization for the user to proceed with production of the creative.

Thus, the present invention provides an apparatus, system and method that would provide a convenient mechanism for application of rules preferred by prospective endorsers before such prospective endorsers would allow use of an endorsement.

### BRIEF DESCRIPTION OF THE FIGURES

Understanding of the present invention will be facilitated by consideration of the following detailed description of the embodiments of the present invention taken in conjunction with the accompanying drawings, in which like numerals refer to like parts and in which:

FIG. 1 is illustrative of the invention;

FIG. 2 is a flow chart of a content approval method, according to an aspect of the present invention; and

FIG. 3 is a flow chart of a multi-step content approval method, according to an aspect of the present invention.

### DETAILED DESCRIPTION OF THE PREFERRED EMBODIMENTS

It is to be understood that the figures and descriptions of the present invention have been simplified to illustrate elements that are relevant for a clear understanding of the present invention, while eliminating, for the purpose of clarity, many other elements found in typical advertising engines, systems and methods. Those of ordinary skill in the art will recognize that other elements and/or steps are desirable and/or required in implementing the present invention. However, because such elements and steps are well known in the art, and because they do not facilitate a better understanding of the present invention, a discussion of such elements and steps is not provided herein. The disclosure herein is directed to all such variations and modifications to such elements and methods known to those skilled in the art. Furthermore, the embodiments identified and illustrated herein are for exemplary purposes only, and are not meant to be exclusive or limited in their description of the present invention.

The present invention is and includes a clearinghouse that allows for the use of approved, copyrightable and/or public persona content by non-owners of such content such as pre-approved photographs, audio, video files, data files, printed text, logos and trademarks, publicity announcements, metatags and metatag streams, and the like. The present invention provides for the use of brand recognition to create brand affinity, at least in that the present invention allows for the use of known and relevant brands in association with endorsed or advertised brands, which endorsement or advertisement is requested by an advertisement requester.

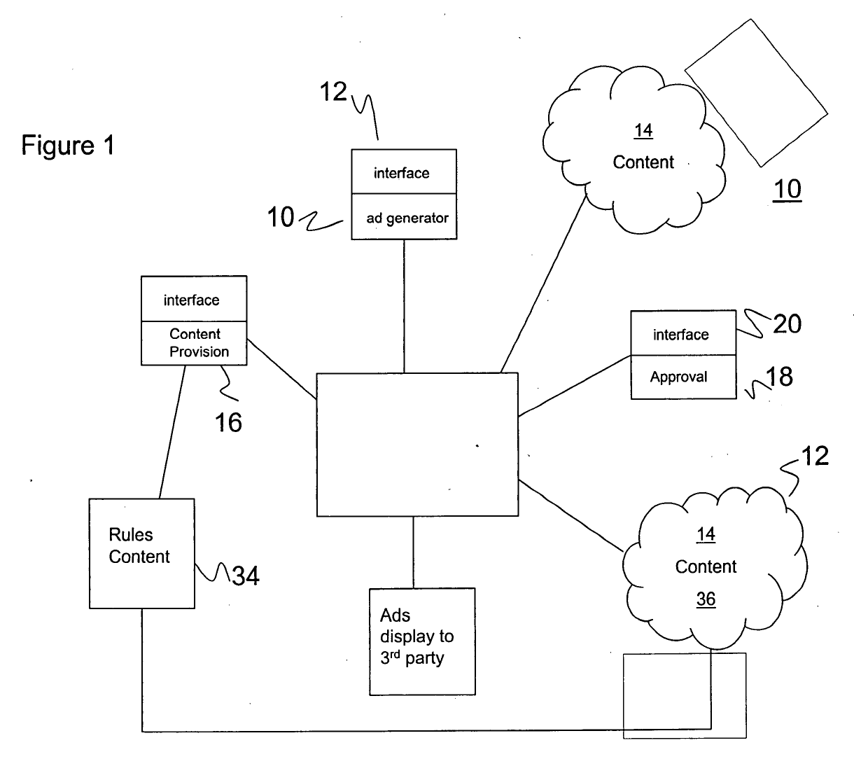

FIG. 1 is illustrative of the present invention. As shown in FIG. 1, the present invention includes at least an advertisement/endorsement generator (hereinafter ad generator) 10, an ad generator interface 12, a content provision rules engine 14, a content provision interface 16, an approval engine 18, and an approval engine interface 20.

In this exemplary embodiment, the ad generator may provide, via the ad generator interface, the capability for a user (also referred to as the ad requester) to create an advertisement, announcement, data file, or the like, with or without an association with an endorser, affiliate, affiliated product, or the like, such as using external content or content from one or more vaults associated with the content provision rules engine discussed further below. The ad generator may provide, for example, a multiplicity of advertisement templates, from among which a user may select a desired advertisement format. Such format may include, for example, a requested endorsement or affiliation. Such endorsement or affiliation may be recommended to the user, such as by endorser or affiliation type, or specific endorsers or affiliates, which specific endorsers or affiliates may be exemplary, a totality of specifics, or menu based or categorically driven. Such suggested endorsers or affiliates may be presented to the user in order to minimize the cost of use of that endorsement or affiliation to the ad requester, in order to maximize the cost of use for that endorsement or affiliation, based on a cost of use range selected by a user, or other similar presentation methodologies, certain of which may be entered by the content provider to the content provision rules engine as discussed below. Through the use of the ad generator via an easy to use ad generator interface, the user may simplistically generate an advertisement or announcement for endorsement or affiliation.

The content provision rules 34 may be accessible to a content-providing user (also referred to as the “owner” of the content, although the providing user may not own the content, but must have a right to control the content) via the content provision interface communicating with the content provision rules engine. The content provision rules engine may allow for the selection by a content provision user of what usages and approvals for usage will be allowable for the content made available by the content provision user. The content 36 provided by the content provision user may be entered directly for storage in the vault(s) through the content provision interface by the content provision user, or may be provided via a link to the content, which link is external to the content provision rules engine and interface, but which link may allow the content rules engine to draw the content from any source in any format. As such, the content provision rules engine may include a normalization engine whereby content may be discerned in any format, or any human or computer language, from any source and normalized to the preferred format employed by the content provision rules engine. As discussed above, the provided content may be audiovisual content, metatag or metatag stream content, or the like.

The usages allowable for the content provided by the content provision user, as per the rules selected or entered, may include usage with regard to particular products, causes, announcements, particular geographies, or the like. Further, such usages may be provided with a cost per use, a cost per bundle of uses, or a cost for permanent usability, for example. The allowable permissions may provide automatic approval for usages entered as being within pre-approved categories, or may provide that certain or all usage requests be forwarded back to the content provision user via the approval engine and approval engine interface for approval. Further, the content provision user may enter that its endorsement or affiliation be available only as a premier use, such as in cases where the rules engine endeavors to upsell an ad requester from a requested level of cost of content to more expensive content. Such premier usages may allow a content provision user to maintain the goodwill and good name of premium brands. As such, the rules engine may include allowances as to which parties using the ad generator should even be offered the content provided for use in endorsements or affiliations.

For example, the content provider may allow for affiliations, endorsements or sponsorships from certain specific entities or certain types of entities, and such affiliations, sponsorships or endorsements may be presented to the ad requester, and may be used, for example, for an additional fee. Such an “upsell” rule 34 may be particularly useful in the event the ad requester has entered only the brand of the ad requester, and not requested additional third party content. In such a case, research, such as third party research, may be imported by the content provision engine to assess whether the ad requested could be improved by an “upsell,” which may be an endorser, affiliate, partner or sponsor available (based on the content provision rules) for the type of ad requested. Such upsell decisions may be based on geography, product type, recognition of the brand in the ad requested, and similar factors. For example, an ad requested for television in Los Angeles for “Super Soap” may be improved if the ad requester is offered an affiliation with Bath and Body Works, and may be further improved (in part due to the geography of the ad in Los Angeles) by an endorsement of the Bath and Body Works affiliation by a famous Los Angeles actress. Likewise, an after-shave commercial may work well as an advertisement during a football game, but after-shave in conjunction with a fantasy sports site sponsor may work even better for the success of the ad.

Thereby, the upsell can be offered to further improve the effectiveness of the ad requested, based on content available via the content provision rules, and/or research that may, or may not, be presented to help convince the ad requester of the propriety of selecting the upsell. For example, such research may include brand recognitions, recognition comparisons, available affiliates, sponsors, endorsers or partners that historically improve brand recognition in particular areas (and that are authorized to be in such an upsell by the content provisions rules).

The example above is by no means limiting with respect to an upsell. Myriad other research may be incorporated for an upsell, as will be apparent to those skilled in the art in view of the disclosure herein. For example, inferences about customers of certain products may be made based on the time of day an audio/visual work to be associated with the requested ad is generally accessed by viewers, sites from which viewers access such content, geographical location of frequent viewers, and the like, and such inferences may be used to upsell an ad requester to ads in a certain geography, at a certain time, or in a certain media outlet. As such, the content provision rules, and the upsells and research associated therewith, may have access to, or be accessible from, advertising and research engines in any media outlet accessible from any communication point in the present invention. Such communication points may, of course, include networked environments, wireless network environments, television, cabled and satellite environments, personal electronic device environments, and the like. Further, the access to the present invention of such external advertising engines may allow for the publishing of new applications, in accordance with the content provisions rules, to the present invention by third party application creators.

The rules engine may allow for provision of the requested content with affiliation, sponsorship, or endorsement in the event that external research has proven that it will not hurt the person or brand that was requested by the ad requester, or in the event that such affiliation, sponsorship or endorsement will help the standing or recognition of the brand or person that was requested by the ad requester.

The approval engine provided to a content provision user via the approval interface may allow for advertisements requested by users of the ad generator to be forwarded back to the content provider for a variety of reasons, including final approval, tracking, and reporting. For example, certain advertisements or endorsements may be automatically approved based on an adherence to the rules entered into the content provision rules engine. However, even such automatically approved endorsements or affiliations may be tracked by, or reported in a requested format to, the content provider. Additionally and alternatively, requested endorsements or affiliations meeting certain criteria may be forwarded back to the content provider, or all requests may be forwarded back to the content provider, for final approval.

The approval process may also include certain pre-approvals of assets by the content provider. For example, the content provider may identify particular assets as having automatic approval for matching, and/or ultimate delivery, as an endorsed ad without further restriction based on an approval rules set, which approval rules set may be an asset in the aforementioned vault, and thus may be uniquely associated with each prospective sponsor/endorser. Pre-approvals may be authorized by both new and existing licenses between the content provider, the system, the user and/or requester of the content. Pre-approvals or automatic approval may also effectively take the form of a license renewal or extension. It goes without saying that although the discussion herein is principally with regard to pre-approval, the discussion herein is likewise applicable to an automatic rejection.

Such pre-approval may expedite the development of a creative for a user by responding to the user request with an asset automatically. Pre-approval rules for a particular asset may include positive or negative restrictions. For example, pre-approval restrictions may be based on a defined geographic area, such as defining that the requested asset may be used only within the greater Chicago area, or the asset may not be used in the Commonwealth of Pennsylvania. In another example, restrictions may be based on a period of time, such as defining that the asset may be used on weekday prime-time hours, or the asset may not be used on Sundays between 12:00 p.m. and 7:00 p.m. In another example, restrictions may be based on pairing or matching with other particular assets, such as the asset may not be used in combination with any erectile dysfunction product, or alternatively, if the targeted asset is the image of a particular talent, such as Terrell Owens, the asset may be restricted from use in combination with any asset associated with another talent, such as Donovan McNabb. In other embodiments, the asset may be used only in specific combinations as defined by an approval rules set. In another example, restrictions may be based on price or cost, such as that the asset may not be used if under a threshold price. It should be appreciated that assets can be restricted or without restriction, and any restrictive rule for pre-approval may be based upon any metric as described herein and as may be associated with the subject asset. It should also be appreciated that any combination of the aforementioned restrictive rules sets, with or without use in conjunction with post or multi-step approval use, may be used to provide a pre-approval or automatic approval mechanism for users to obtain authorization from content providers. For example, the content provider for a specific asset representing Shawne Merriman may allow automatic approval for users willing to pay a set price per minute for use in the greater San Diego area at non-primetime viewing hours and not during any time in which a National Football League game is being played, and which is associated only with the sale of new and/or used automobiles. It should be understood that there is no limit to the number and application for creating combinations of an approval rules set for use with the present invention. Further, needless to say, a request may, based on a rule for example, be forwarded, or forwarded upon a certain occurrence, to an asset owner or one associated with an asset owner for approval of use or the requested asset at any point in the process discussed herein.

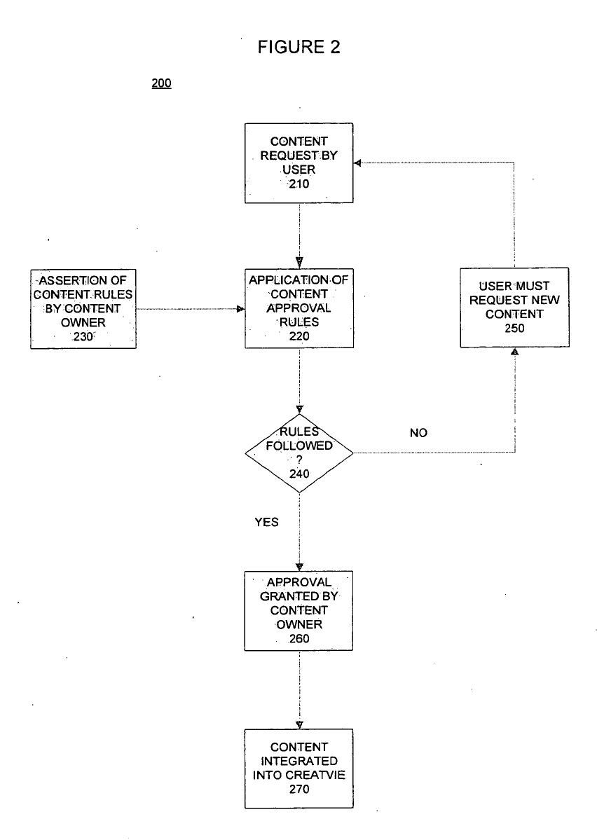

The present invention may also include a method performing the automatic or pre-approval mechanisms as described hereinabove. For example, as shown in FIG. 2, method 200 may be initiated by a user making a request 210 to use of a particular content item. The system then applies all approval rules 220 against the information entered by the user in the content request 210. The rules applied at step 220 are all rules asserted by the content owner 230 that are associated with the particular content requested, and preferably, but not exclusively, only those rules that were asserted prior to the time that the request for content 210 was made. At step 240, a determination is made whether the approval rules were met. If not, the user must either terminate the adoption of that particular content, or the user must request new content 250 to initiate the process again from the beginning. If the determination at step 240 is yes, then an approval is granted 260 by the ‘content owner without the need for a content owner confirmation. The approved content can then be integrated 270 into an ad or creative as proposed by the user.

The approval system may also include a series of approvals, or a multi-step approval (or multi-step rejection) process, for allowing assets to be searched, matched and/or delivered for integration with a creative and/or campaign. For example, as described above, the asset may be initially approved for use in a creative automatically based on a set of pre-approval rules. While this initial approval is valid, the creative may change subsequent to the automatic approval or include multiple assets selected independently and subject to multiple approvals, as it should be appreciated that a given creative may include many different assets within a multi-layer, or hierarchical, format and/or rules format. In such a case, the creative having the pre-approved asset may be sent to the content provider for a second or subsequent approval. The subsequent approval may provide the content provider of the initially approved or pre-approved asset to screen, filter or otherwise provide the ability to override an initial approval based upon those features added or altered in the creative subsequent to the initial approval. For example, the initially approved asset may end up in a creative that has a background that the content provider finds offensive or detrimental to the image or value of the asset.

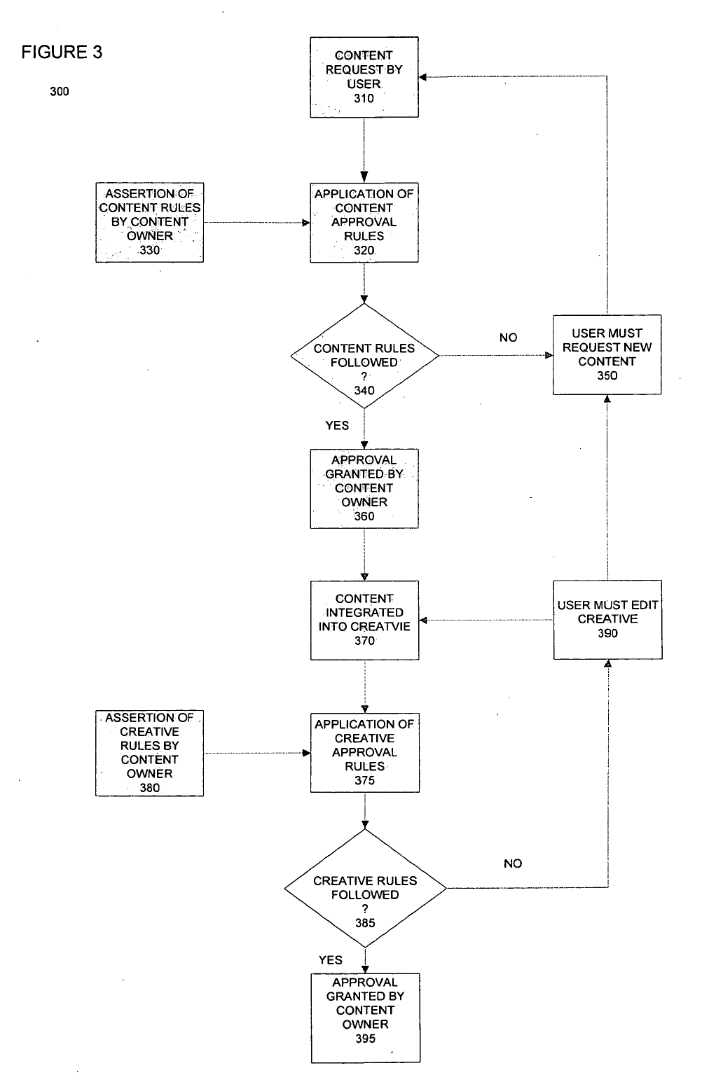

The present invention may also include a method performing a multi-step automatic or pre-approval mechanisms as described hereinabove. For example, as shown in FIG. 3, method 300 may be initiated by a user making a request 310 to use of a particular content item. The system then applies all approval rules 320 against the information entered by the user in the content request 310. The rules applied at step 320 are all rules asserted by the content owner 330 that are associated with the particular content requested, and preferably, but not exclusively, only those rules that were asserted prior to the time that the request for content 310 was made. At step 340, a determination is made whether the approval rules were met. If not, the user must either terminate the adoption of that particular content, or the user must request new content 350 to initiate the process again from the beginning. If the determination at step 340 is yes, then an approval is granted 360 by the content owner without the need for a content owner confirmation. The approved content can then be integrated 370 into an ad or creative as proposed by the user. The system then applies a second set of approval rules 375 against the information entered by the user with regard to the content's integration into the creative 370. The rules applied at step 375 are all rules asserted by the content owner 380 that are associated with the particular initially approved content as it integrates with the other components of the creative. At step 385, a determination is made whether the approval rules were met. If not, the user must either terminate the adoption of that particular content with the creative, or the user must edit the creative 390 and initiate the process again at step 370. Alternatively, the user may determine that the initially approved content must be changed, and thus go all the way back to step 310 in the selection of new content. If the determination at step 385 is yes, then a second approval is granted 395 by the content owner without the need for a content owner confirmation. The approved content can then be used in either further development of the creative, a campaign, or other phase as offered by the system.

This multi-step approval mechanism may give the content provider assurances that sufficient quality control measures are being taken, and the image, persona and/or reputation of the talent associated with a particular media asset is not losing value due to use of the asset in a particular advertising campaign.

The present invention thereby allows for the avoidance of brand dilution, such as by allowing approvals of limited usage, such as in limited geographic areas, of certain endorsements or affiliations. For example, a Philadelphia athlete may feel that his or her likeness is overused in the Philadelphia area, but may be more than willing to expand that athlete's brand into California for use as an endorser of Philadelphia-themed restaurants in California who wish to use his or her likeness. Further, certain very well respected entities, such as the American Cancer Society, may wish to expand the awareness or influence of their particular causes, but may wish to do so only by affiliation with publicly acceptable causes that support their causes, or with non-profit causes, or the like. Such allowable uses, or exclusions, may be entered as content provision rules.

As such, the present invention may provide for a clearinghouse for any and all copyrightable, trademarked, and/or public persona content.

Although the invention has been described and pictured in an exemplary form with a certain degree of particularity, it is understood that the present disclosure of the exemplary form has been made by way of example, and that numerous changes in the details of construction and combination and arrangement of parts and steps may be made without departing from the spirit and scope of the invention as set forth in the claims hereinafter.

Those of ordinary skill in the art will recognize that many modifications and variations of the present invention may be implemented without departing from the spirit or scope of the invention. Thus, it is intended that the present invention cover the modification and variations of this invention provided they come within the scope of the appended claims and their equivalents.

1. A multi-step approval engine for approving at least one content, comprising:
a creative generator having a graphical user interface through which a user interacts with said creative generator, wherein the user requests the at least one content not previously associated with the user for inclusion in a creative generated via said creative generator;
a content provision rules engine, including:
a first plurality of rules asserted by an owner of the requested at least one content to govern inclusion of the content in the creative, wherein ones of the first plurality of rules includes a minimum price;
a second plurality of rules asserted by the owner of the requested content to review the creative subsequent to inclusion of the requested content in the creative pursuant to the first plurality of rules;
a content provision interface by which the owner of the requested content interacts to assert at least the second plurality of rules;
wherein said creative generator generates the creative including the requested content in accordance with a satisfaction of the first plurality of rules and the second plurality of rules.

2. The approval engine of claim 1, wherein the first plurality of rules comprises a pre-approved.

3. The approval engine of claim 1, wherein the second plurality of rules comprises a post approval.

4. The approval engine of claim 1, wherein the requested creative comprises a modified requested creative after application of the first plurality of rules.

5. The approval engine of claim 1, wherein the second plurality is hierarchical to the first plurality.

6. The approval engine of claim 1, wherein the second plurality comprises an automated filter.

7. The approval engine of claim 1, wherein the interaction to assert the second plurality comprises entry of the second plurality to said content provision interface.

8. The approval engine of claim 1, wherein the interaction to assert the second plurality comprises an active interaction after application of the first plurality.

9. The approval engine of claim 1, wherein the interaction to assert the second plurality is automated.

10. The approval engine of claim 1, wherein the interaction to assert comprises the review of the creative subsequent to the inclusion.

11. The approval engine of claim 1, wherein the second plurality comprises an override.

12. The approval engine of claim 1, wherein said content provision interface comprises an override interface.

13. The approval engine of claim 1, wherein the second plurality comprises quality control.

14. The approval engine of claim 1, wherein the first plurality further comprises at least one geographic restriction.

15. The approval engine of claim 1, wherein the first plurality comprises at least one time restriction.

16. The approval engine of claim 1, wherein the second plurality comprises at least one pairing restriction.

17. The approval engine of claim 1, wherein the at least one content comprises audio.

18. The approval engine of claim 1, wherein the at least one content comprises video.

19. The approval engine of claim 1, wherein the owner comprises a subject of the at least one content.

20. The approval engine of claim 1, further comprising at least a third plurality of rules, applied prior to application of said second plurality of rules, wherein application of said second plurality is contingent upon satisfaction of said third plurality.
